(19) United States
(12) Patent Application Publication
(10) Pub. No.: US 2008/0069429 A1
(43) Pub. Date: Mar. 20, 2008

(54) Method and Apparatus for Registering a Reference Image, and Method and Apparatus for Testing a Pattern Using the Same

(76) Inventors: Byung-Sam Choi, Suwon-si (KR); Bong-Su Kim, Suwon-si (KR); Young-Nam Kim, Suwon-si (KR); Ho-Seong Kang, Seongnam-si (KR); Joung-Soo Kim, Hwascong-si (KR); Jun-Seog Kim, Yongin-si (KR)

Correspondence Address: F. CHAU & ASSOCIATES, LLC, 130 WOODBURY ROAD, WOODBURY, NY, 11797, US

(21) Appl. No.: 11/777,479

(22) Filed: Jul. 13, 2007

(30) Foreign Application Priority Data
Jul. 13, 2006 (KR) 2006-65749

(51) Int. Cl. G06K 9/00

(52) U.S. Cl. 382/141

(57) ABSTRACT

A method of registering a reference image includes obtaining information of layers in a design pattern that is used for forming an actual pattern on a substrate and comparing the information to obtain a difference therebetween. The method further includes obtaining a reference image for testing the actual pattern based on the difference. Thus, the reference image, which is obtained from the design pattern, but not from the actual pattern, may include information on all of the actual patterns on the substrate.

### CROSS-REFERENCE TO RELATED APPLICATION

This application claims priority under 35 USC §119 to Korean Patent Application No. 2006-65749 filed on Jul. 13, 2006, the disclosure of which is hereby incorporated by reference herein in its entirety.

### BACKGROUND OF THE INVENTION

1. Technical Field

The present disclosure relates to a method and an apparatus for registering a reference image, and to a method and an apparatus for testing a pattern using the same. More particularly, the present disclosure relates to a method and an apparatus for registering a reference image that is used for testing a pattern on a semiconductor substrate, and to a method and an apparatus for testing a pattern using the above-mentioned method and apparatus.

2. Description of the Related Art

Generally, a semiconductor device may be manufactured by hundreds of processes. Various patterns are formed on a semiconductor substrate by these processes. Moreover, it may be required that patterns with characteristics corresponding to predetermined process recipes also be provided. Thus, a process for testing the pattern is carried out between the processes. The test process examines whether the patterns are formed to have a thickness, a critical dimension (CD), etc. in accordance with those planned.

According to a conventional method of testing a pattern, an electron beam is irradiated to one of patterns on a semiconductor substrate. A reference image is obtained based on a scattered electron beam irradiated from the pattern. The reference image is compared to the rest of the images on the semiconductor substrate to determine whether the images are to be normal or not.

For example, in the conventional method, the reference image is obtained from an actual pattern formed on the semiconductor substrate. The rest of the actual patterns are determined to be normal using the reference image.

Here, the reference image is required to provide average information of the actual patterns. However, the reference image obtained from the actual pattern may not include all of the average information of the entire actual patterns, but rather, the actual pattern for obtaining the reference image may be abnormal. For example, when the actual pattern has vague contrast, the reference image obtained from the actual pattern may also have vague contrast. Therefore, when comparing the reference image having the vague contrast with the rest actual patterns, an actual pattern having contrast clearer than that of the reference image may be determined to be abnormal.

Further, when the electron beam is irradiated to the actual pattern to obtain the reference image, the actual pattern may be slightly reduced by a physical reaction between the electron beam and the actual pattern. Thus, the reference image obtained from the slightly reduced actual pattern may not include all of the information with respect to the entire actual patterns. As a result, the conventional method may have low test reliability.

Furthermore, to obtain the reference image using the conventional method, the actual pattern should be prepared to be compared. For example, when using the above-mentioned conventional method, only after the actual pattern is formed on the semiconductor substrate, the reference image may be then obtained from the actual pattern, and the test on the actual patterns may be carried out using the reference image. As a result, it may take a significant amount of time to run a test on the actual patterns.

### SUMMARY OF THE INVENTION

Exemplary embodiments of the present invention provide a method of registering a reference image that includes all information with respect to entire actual patterns on a semiconductor substrate.

Exemplary embodiments of the present invention also provide an apparatus for performing the above-mentioned registering method.

Exemplary embodiments of the present invention still also provide a method of testing an actual pattern using the registering method.

Exemplary embodiments of the present invention yet still also provide an apparatus for performing the above-mentioned testing method.

In accordance with an exemplary embodiment of the present invention, a method of registering a reference image is provided. The method includes obtaining information of layers in a design pattern that is used for forming an actual pattern on a substrate, comparing the information to obtain a difference therebetween and obtaining a reference image for testing the actual pattern based on the difference.

According to an exemplary embodiment, the information may include brightness of layers. Further, a process to obtain the brightness may include irradiating a light to the layers, and acquiring the brightness based on a reflected light from the layers.

In accordance with an exemplary embodiment of the present invention, an apparatus for registering a reference image is provided. The apparatus includes an information-obtaining unit, an information-comparing unit and an image-registering unit. The information-obtaining unit obtains information of layers in a design pattern that is used for forming an actual pattern on a substrate. The information-comparing unit compares the information to obtain a difference therebetween. The image-registering unit registers a reference image for testing the actual pattern based on the difference.

According to an exemplary embodiment, the information may include brightness of layers. Further, the information-obtaining unit includes an emitter for irradiating a light to the layers, a receiver for receiving a reflected light from the layers, and a light processor for obtaining the brightness based on the reflected light.

In accordance with still another exemplary embodiment of the present invention, a method of testing a pattern on a substrate is provided. The method includes obtaining information of layers in a design pattern that is used for forming an actual pattern on the substrate, comparing the information to obtain a difference therebetween, obtaining a reference image for testing the actual pattern based on the difference and obtaining an actual image of the actual pattern. The method further includes comparing the actual image to the reference image and determining whether the actual pattern is to be normal or not based on the comparison results.

In accordance with an exemplary embodiment of the present invention, an apparatus for testing a pattern on a substrate is provided. The apparatus includes an information-obtaining unit, an information-comparing unit, an image-registering unit, an image-obtaining unit, an image-comparing unit and a pattern-determining unit. The information-obtaining unit obtains information of layers in a design pattern that is used for forming an actual pattern on the substrate. The information-comparing unit compares the information to obtain a difference therebetween. The image-registering unit registers a reference image for testing the actual pattern based on the difference. The image-obtaining unit obtains an actual image of the actual pattern. The image-comparing unit compares the actual image to the reference image. The pattern-determining unit determines whether the actual pattern is to be normal or not based on the comparison results of the image-comparing unit.

According to exemplary embodiments of the present invention, the reference image is obtained from the design pattern, not the actual pattern. For example, the reference image obtained from the design pattern may clearly reflect contrast difference of the layers in the design pattern so that the reference image may include information of all of the actual patterns on the substrate. Further, as the reference image is not obtained using a light, slight reduction of the reference image due to the light may be prevented. As a result, when the actual patterns are tested using the reference image, test results may have improved reliability.

### BRIEF DESCRIPTION OF THE DRAWINGS

Exemplary embodiments of the present invention can be understood in more detail from the following detailed description taken in conjunction with the accompanying drawings wherein:

FIG. 1 is a block diagram illustrating an apparatus for registering a reference image in accordance with an exemplary embodiment of the present invention;

FIG. 2 is a flow chart illustrating a method of registering a reference image using the apparatus in FIG. 1;

FIG. 3 is a scanning electron microscope (SEM) picture illustrating a mask pattern that is used for a design pattern in the exemplary embodiment of FIG. 1;

FIG. 4 is a block diagram illustrating an apparatus for testing a pattern on a substrate in accordance with an exemplary embodiment of the present invention;

FIG. 5 is a flow chart illustrating a method of testing a pattern on a substrate using the apparatus in FIG. 4;

FIG. 6 is a plan view illustrating a reference sample image and an actual sample image in accordance with Comparative Example; and

FIG. 7 is a plan view illustrating a reference sample image and an actual sample image in accordance with an exemplary embodiment of the present invention.

### DETAILED DESCRIPTION OF THE EXEMPLARY EMBODIMENTS OF THE INVENTION

The present invention is described more fully hereinafter with reference to the accompanying drawings, in which exemplary embodiments of the invention are shown. This invention may, however, be embodied in many different forms and should not be construed as limited to the embodiments set forth herein. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

### Exemplary Embodiment 1

Apparatus for Registering a Reference Image

FIG. 1 is a block diagram illustrating an apparatus for registering a reference image in accordance with a first exemplary embodiment of the present invention.

Referring to FIG. 1, an apparatus 100 for registering a reference image of this exemplary embodiment includes an information-obtaining unit 110, an information-comparing unit 120 and an image-registering unit 130.

The information-obtaining unit 110 obtains information with respect to a design pattern for forming an actual pattern on a semiconductor substrate. That is, in this exemplary embodiment, a reference image is obtained from the design pattern for forming the actual pattern, but not from the actual pattern on the semiconductor substrate. For example, to form a photoresist pattern on the semiconductor substrate, a mask pattern having a shape that corresponds to that of the photoresist pattern is used. The information-obtaining unit 110 obtains the information of layers in the mask pattern. Here, as the actual pattern is formed using the mask pattern, the information of the layers in the mask pattern may include all information on the actual pattern.

For example, the mark pattern includes a plurality of the layers. For example, the layers have brightness different from each other, thereby generating a contrast difference between the brightness of the layers. The information-obtaining unit 110 obtains the brightness of the layers using a light.

To obtain the brightness of the layers, the information-obtaining unit 110 includes an emitter 111 for irradiating the light to the mask pattern, a receiver 112 for receiving a reflected light from the mask pattern, and a light processor 113 for obtaining the brightness of the layers based on the received light.

The information-comparing unit 120 compares the brightness of the layers obtained by the information-obtaining unit 110 to measure the contrast difference between the brightness.

The image-registering unit 130 obtains the reference image based on the contrast difference measured by the information-comparing unit 120. For example, as described above, there is the contrast difference between the layers on the mask pattern. This contrast difference may include all of the contrast differences between layers in the actual pattern so that the reference image obtained from the mask pattern may represent all of the actual patterns. That is, layers in the reference image may have clear contrast difference.

Method of Registering a Reference Image

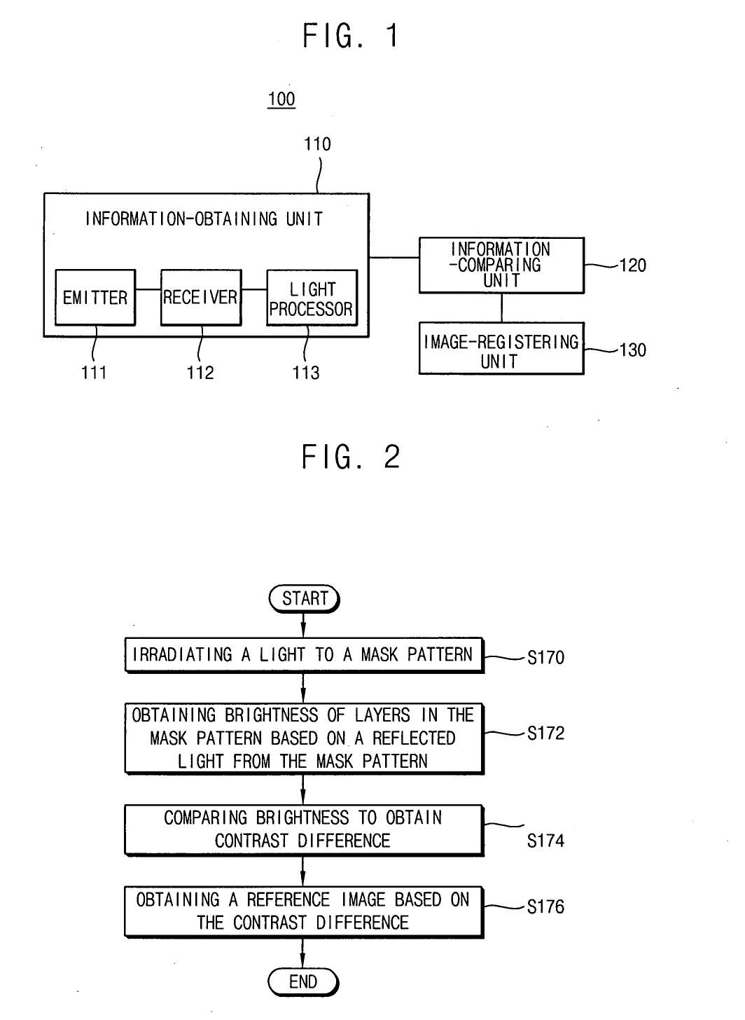

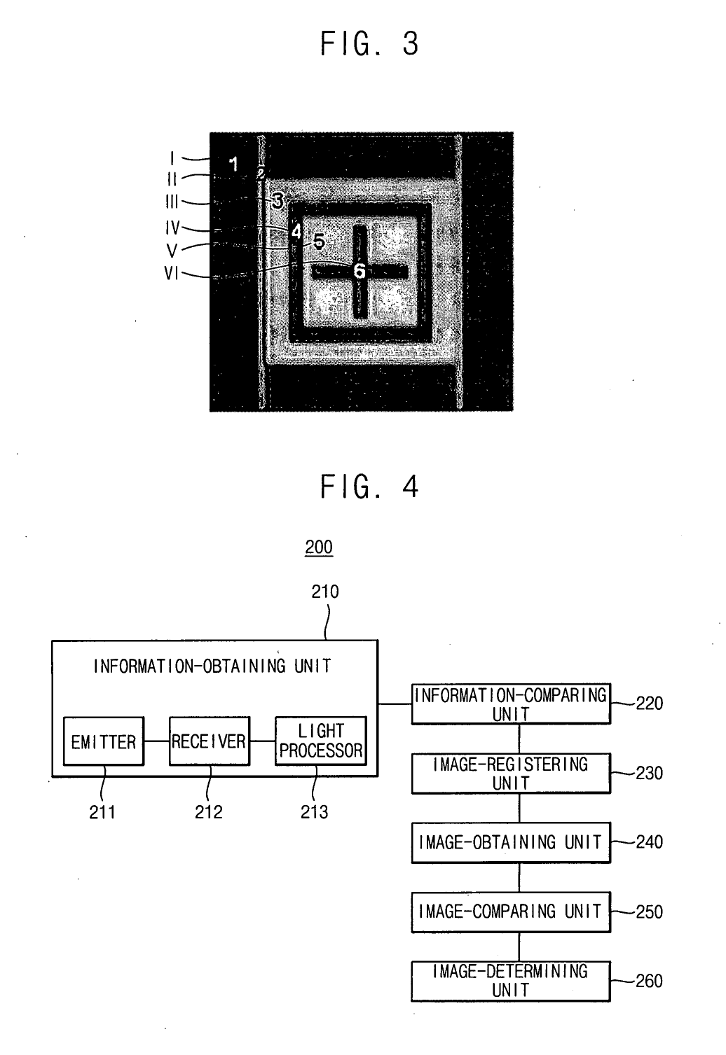

FIG. 2 is a flow chart illustrating a method of registering a reference image using the apparatus in FIG. 1, and FIG. 3 is a scanning electron microscope (SEM) picture illustrating a mask pattern that is used for a design pattern in the first exemplary embodiment.

Referring to FIG. 3, in this exemplary embodiment, six layers are formed on the mask pattern to define first to sixth regions I, II, III, IV, V and VI on the mask pattern. Here, the first region I is a dark region corresponding to a surface of the mask pattern. The second region II has two bright linear shapes on the first region 1. The third region III has a bright rectangular shape in the second region II. The fourth region IV has a dark rectangular annular shape in the third region III. The fifth region V has a bright rectangular shape in the fourth region IV. The fourth region VI is a dark cross shape in the fifth region V Referring to FIGS. 1 and 2, in step S170, the emitter 111 irradiated the light to the mask pattern.

In step S172, the receiver 112 receives lights reflected from the first to sixth regions I, II, III, IV, V and VI. Here, the reflected lights include information with respect to brightness of the first to sixth regions I, II, III, IV, V and VI. The light processor 113 processes the information of the reflected lights in the receiver 112 to obtain the brightness of the first to sixth regions I, II, III, IV, V and VI.

In step S174, the information-comparing unit 120 compares the brightness of the first to sixth regions I, II, III, IV, V and VI to obtain contrast difference between the brightness.

In step S176, the image-registering unit 130 registers a reference image based on the contrast difference obtained by the information-comparing unit 120. Here, the reference image may have a shape substantially the same as that of the mask pattern in FIG. 3. For example, layers in the reference image may have brightness which is substantially the same as those of the first to sixth regions I, II, III, IV, V and VI on the mask pattern. Therefore, the layers of the reference image may have clear contrast difference. Further, the reference image may be obtained from the mask pattern, e.g., the design pattern, but not from the actual pattern so that a size of the reference image may be readily controlled.

According to this exemplary embodiment, the reference image is obtained from the design pattern, but not from the actual pattern on the semiconductor substrate so that the layers in the reference image may have clear contrast difference. Thus, the reference image may include all of the information with respect to the actual pattern on the semiconductor substrate. As a result, an optimal reference image may be registered using the method and apparatus of the present invention.

### Exemplary Embodiment 2

Apparatus for Testing a Pattern on a Substrate

FIG. 4 is a block diagram illustrating an apparatus for testing a pattern on a substrate in accordance with a second exemplary embodiment of the present invention.

Referring to FIG. 4, an apparatus 200 for testing a pattern on a substrate of this exemplary embodiment includes an information-obtaining unit 210, an information-comparing unit 220, an image-registering unit 230, an image-obtaining unit 240, an image-comparing unit 250 and a patter-determining unit 260.

The information-obtaining unit 210 obtains information with respect to a design pattern for forming an actual pattern on a semiconductor substrate. In this exemplary embodiment, the design pattern includes a mask pattern. The information-obtaining unit 210 includes an emitter 211 for irradiating the light to the mask pattern, a receiver 212 for receiving a reflected light from the mask pattern, and a light processor 213 for obtaining the brightness of the layers based on the received light.

The information-comparing unit 220 compares the brightness of the layers obtained by the information-obtaining unit 210 to measure the contrast difference between the brightness.

The image-registering unit 230 obtains the reference image based on the contrast difference measured by the information-comparing unit 220.

The image-obtaining unit 240 obtains an actual image of the actual pattern on the semiconductor substrate. For example, the image-obtaining unit 240 obtains the actual image of the actual pattern using information in a light reflected from the actual pattern.

The reference image is inputted into the image-comparing unit 250. The image-comparing unit 250 compares the actual image to the reference image. Here, the image-comparing unit 250 overlaps the actual image with the reference image to compare them with each other.

The pattern-determining unit 260 determines whether the actual image is to be normal or not based on the comparison results of the image-comparing unit 250. Here, as the reference image has contrast difference clearer than those of the actual images, the reference image may include all of the information with respect to the actual images. As a result, test results with respect to the actual patterns using the apparatus of this example embodiment may have improved reliability.

Method of Testing a Pattern on a Substrate

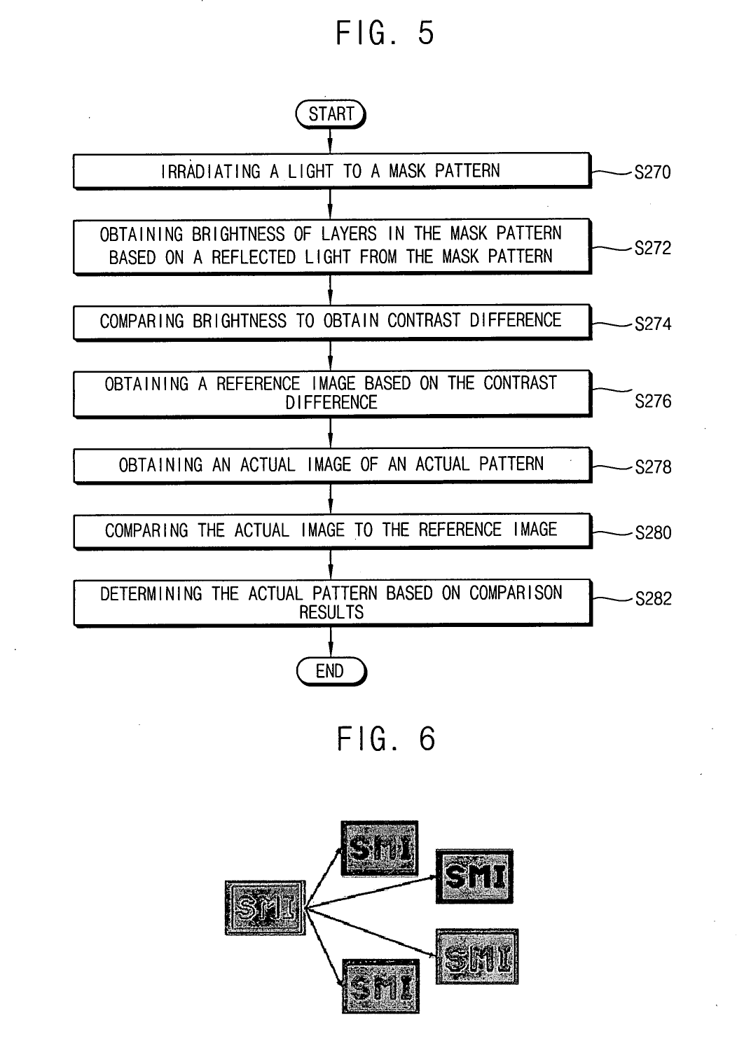

FIG. 5 is a flow chart illustrating a method of testing a pattern on a substrate using the apparatus in FIG. 4.

Referring to FIGS. 4 and 5, in step S270, the emitter 211 irradiates the light to the mask pattern.

In step S272, the receiver 212 receives lights reflected from layers in the mask pattern. The light processor 213 processes the information of the reflected lights in the receiver 212 to obtain the brightness of the layers in the mask pattern.

In step S274, the information-comparing unit 220 compares the brightness of the layers in the mask pattern to obtain the contrast difference therebetween.

In step S276, the image-registering unit 230 registers a reference image based on the contrast difference obtained by the information-comparing unit 220. The reference image is inputted into the image-comparing unit 250.

Actual patterns are formed on the semiconductor substrate using the mask pattern. In step S278, the image-obtaining unit 240 obtains actual images of the actual patterns on the semiconductor substrate.

In step S280, the image-comparing unit 250 compares the actual images to the reference image. For example, the image-comparing unit 250 overlaps the actual images with the reference image to examine whether the actual images are aligned with the reference image.

In step S282, the pattern-determining unit 260 determines whether the actual patterns are to be normal or not based on the comparison results. Here, the reference image has a contrast difference which is clearer than those of the actual images. Thus, the reference image may include all of the information with respect to the actual patterns on the semiconductor substrate. As a result, the test results outputted by using the method of this exemplary embodiment may have improved reliability.

Evaluating Capacity for Testing a Pattern

Comparative Example

A photoresist layer over a semiconductor substrate was exposed and developed using a mask pattern having a character shown as “SMI” to form a photoresist pattern having a character that corresponded to the “SMI” character. An insulation layer was etched using the photoresist pattern as an etching mask to form a plurality of insulation layer patterns having a “SMI” character.

An image was obtained from any one of the insulation layer patterns. The image was registered as a reference image. Actual images obtained from the insulation layer patterns were compared to the reference image.

As shown in FIG. 6, the reference image obtained in accordance with Comparative Example has a vague contrast difference. Thus, when a normal actual image having contrast difference clearer than that of the reference image is compared to the reference image, the normal actual image is determined to be abnormal. That is, as the reference image does not include information with respect to the normal actual image having the clear contrast difference, the normal actual image is determined to be abnormal.

Testing an Insulation Pattern Using the Method of the Present Invention

A reference image was obtained from a mask pattern having “SMI” character. A photoresist layer over a semiconductor substrate was exposed and developed using the mask pattern having the “SMI” character to form a photoresist pattern having a character that corresponded to the “SMI” character. An insulation layer was etched using the photoresist pattern as an etching mask to form a plurality of insulation layer patterns having “SMI” character.

Actual images obtained from the insulation layer patterns were compared to the reference image.

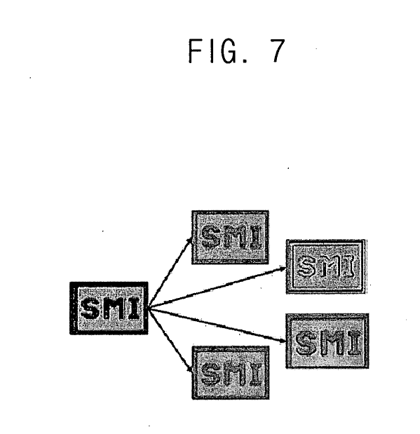

As shown in FIG. 7, the reference image obtained using the method of exemplary embodiments of the present invention has a clearer contrast difference. Thus, the reference image includes information with respect to all of the normal actual images. As a result, when a test on the actual images is carried out using the reference image having the clearer contrast difference, test result of the actual images may have improved reliability.

According to exemplary embodiments of the present invention, the reference image is obtained from the design pattern, but not from the actual pattern so that the reference image may include the information with respect to all of the actual patterns on the semiconductor substrate.

Further, as the reference image is not obtained using a light, slight reduction of the reference image due to the light may be prevented.

As a result, when the actual patterns are tested using the reference image, test results may have improved reliability.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A method of registering a reference image, comprising:
obtaining information of layers in a design pattern that is used for forming an actual pattern on a substrate;
comparing the information to obtain a difference therebetween; and
obtaining a reference image for testing the actual pattern based on the difference.

2. The method of claim 1, wherein the information comprises brightness of the layers.

3. The method of claim 2, wherein obtaining the brightness comprises:
irradiating a light to the layers; and
obtaining the brightness based on a reflected light from the layers.

4. The method of claim 1, wherein the substrate comprises a semiconductor substrate, and the design pattern comprises a mask pattern.

5. An apparatus for registering a reference image, comprising:
an information-obtaining unit for obtaining information of layers in a design pattern that is used for forming an actual pattern on a substrate;
an information-comparing unit for comparing the information to obtain a difference therebetween; and
an image-registering unit for registering a reference image for testing the actual pattern based on the difference.

6. The apparatus of claim 5, wherein the information comprises brightness of the layers, and
the information-obtaining unit comprises:
an emitter for irradiating a light to the layers;
a receiver for receiving a reflected light from the layers; and
a light processor for obtaining the brightness based on a reflected light from the layers.

7. A method of testing a pattern on a substrate, comprising:
obtaining information of layers in a design pattern that is used for forming an actual pattern on a substrate;
comparing the information to obtain a difference therebetween;
obtaining a reference image for testing the actual pattern based on the difference;
obtaining an actual image of the actual pattern;
comparing the actual image to the reference image; and
determining whether the actual pattern is to be normal or not based on the comparison results.

8. The method of claim 7, wherein the information comprises brightness of the layers.

9. The method of claim 7, wherein the substrate comprises a semiconductor substrate, and the design pattern comprises a mask pattern.

10. An apparatus for testing a pattern on a substrate, comprising:
an information-obtaining unit for obtaining information of layers in a design pattern that is used for forming an actual pattern on a substrate;
an information-comparing unit for comparing the information to obtain a difference therebetween;
an image-registering unit for registering a reference image for testing the actual pattern based on the difference;
an image-obtaining unit for obtaining an actual image of the actual pattern;
an image-comparing unit for comparing the actual image to the reference image; and
a pattern-determining unit for determining whether the actual pattern is to be normal or not based on the comparison results of the image-comparing unit.

11. The apparatus of claim 10, wherein the information comprises brightness of the layers, and
the information-obtaining unit comprises:
an emitter for irradiating a light to the layers;
a receiver for receiving a reflected light from the layers; and
a light processor for obtaining the brightness based on a reflected light from the layers.

12. The apparatus of claim 10, wherein the substrate comprises a semiconductor substrate, and the design pattern comprises a mask pattern, and
the information-obtaining unit comprises:
an emitter for irradiating a light to the mask pattern;
a receiver for receiving a reflected light from the mask pattern; and
a light processor for obtaining the brightness of the layers based on the received light.

13. The apparatus of claim 12, wherein the information comparing unit compares the brightness of the layers obtained by the information-obtaining unit to measure a contrast difference between brightness.

14. The apparatus of claim 13, wherein the image registering unit obtains the reference image based on the contrast difference measured by the information-comparing unit.
